(19) United States
(12) Patent Application Publication
(10) Pub. No.: US 2006/0030659 A1
(43) Pub. Date: Feb. 9, 2006

(54) Low warp polybutylene terephthalate molding compositions

(76) Inventor: Paul DeStio, Middlesex, NJ (US)

Correspondence Address: FERRELLS, PLLC, P. O. BOX 312, CLIFTON, VA, 20124-1706, US

(21) Appl. No.: 10/914,697

(22) Filed: Aug. 9, 2004

(51) Int. Cl. C08K 3/40

(52) U.S. Cl. 524/494

(57) ABSTRACT

A low warp, reinforced polybutylene terephthalate molding composition includes: from about 30 weight percent to about 70 weight percent of polybutylene terephthalate resin; from about 10 weight percent to about 30 weight percent of a styrene-acrylonitrile copolymer; from about 15 to about 60 weight percent of a reinforcing agent; and optionally includes one or more impact modifiers, lubricants and stabilizers.

### TECHNICAL FIELD

The present invention relates generally to reinforced thermoplastic molding compositions. More specifically the invention relates to glass fiber reinforced polybutylene terephthalate molding compositions provided with a warp-reducing amount of styrene-acrylonitrile copolymer.

### BACKGROUND

General background with respect to blended thermoplastic molding compositions is seen in U.S. Pat. No. 4,665,122 entitled “Polycarbonate Blends” of Robeson et al. The '122 patent discloses a blend of polycarbonate and a styrenic polymer. The styrenic polymer used is a styrene acrylonitrile copolymer (SAN). The ratio of styrene copolymer to the polycarbonate varies according to end properties sought and in the usual case is from about 25 to 75 weight percent of the polycarbonate to about 75 to 25 weight percent of the styrenic polymer. Typical additives include UV stabilizers, antioxidants, flame retardants, inorganic fillers, fiberglass, and carbon fibers.

Another thermoplastic blend is found in U.S. Pat. No. 4,493,921 entitled “Impact Resistant Blend” of Wefer. Here, the blends are based on thermoplastic polyester resin such as polybutylene terephthalate, aromatic polycarbonate resin and graft copolymers of EPDM or EPM. The grafting monomer may be styrene/acrylonitrile. Preferred compositions will include a major proportion of the polyester resin component along with sufficient polycarbonate resin and graft copolymer to provide high notched impact strength.

U.S. Pat. No. 5,106,907 entitled “Engineering Thermoplastic with Improved Processability and Performance” of Boutni discloses a four component blend including an aromatic carbonate polymer, a styrene-acrylonitrile copolymer, a methacrylate-diene-styrene shell-core copolymer and polybutylene terephthalate “PBT”. The styrene-acrylonitrile copolymer is present in about 2% to about 15% (preferably from about 4% to 10%), from about 2% to about 20% (preferably from about 3% to about 12%) of the core-shell polymer, and from about 2% to about 50% (preferably for about 4% to about 15%) of the polybutylene terephthalate, with the remainder of the four-component blend being essentially the aromatic carbonate. The blend may be modified by the addition of additives such as clay or talc fillers, reinforcing agents such as glass fibers, impact modifiers, other resins, plasticizers, flow promoters and other processing aids, stabilizers, colorants, mold release agents, flame retardants, ultraviolet screening agents, and the like.

Turning more specifically to PBT reinforced resin compositions, there is taught in U.S. Pat. No. 4,900,610 to Hochberg et al. PBT molding compositions wherein the matrix resin is augmented with cyclohexane dimethanol/terephalic acid copolymer. As noted in U.S. Pat. No. 4,900,610, reinforced PBT compositions have a tendency to warp. See Col. 1, lines 29 and following.

One known way to reduce warpage in PBT molding compositions is to add polycarbonate to the blend; however such compositions tend to exhibit very high melt viscosities resulting in poor mold cavity filling. Moreover, added polycarbonate tends to reduce heat resistance significantly as is seen in the example compositions described hereafter.

### SUMMARY OF INVENTION

It has been found in accordance with the present invention that styrene-acrylonitrile copolymer significantly reduces warp exhibited by reinforced PBT compositions. The inventive compositions do not exhibit the high melt viscosities seen in PBT/polycarbonate blends and have surprisingly high deflection temperatures under load as compared with other PBT/polymer blends.

There is thus provided in accordance with the present invention a low warp, reinforced polybutylene terephthalate molding composition comprising: (a) from about 30 weight percent to about 70 weight percent of polybutylene terephthalate resin; (b) from about 10 weight percent to about 30 weight percent of a styrene-acrylonitrile copolymer; (c) from about 15 to about 60 weight percent of a reinforcing agent; and (d) optionally including one or more impact modifiers, lubricants and stabilizers. Preferably, the polybutylene terephthalate resin is present in an amount of from about 40 weight percent to about 60 weight percent and has an intrinsic viscosity of from about 0.4 to about 4.0. An intrinsic viscosity of from about 0.6 to about 1.5 is still more preferred.

Typically the styrene-acrylonitrile copolymer is present in an amount of from about 15 to about 25 weight percent and has a melt index of from about 2 g/10 min to about 10 g/10 min at 230° C./3.8 kg. A melt index of from about 2 g/10 min to about 9 g/10 min at 230° C./3.8 kg is more preferred, while a melt index of from about 3 g/10 min to about 3.5 g/10 min at 230° C./3.8 kg is still more preferred.

In most cases the amount of polybutylene terephthalate resin present is at least 1.5 times the amount of styrene-acrylonitrile copolymer present on a weight basis and preferably the amount of polybutylene terephthalate resin present is at least 2 times the amount of styrene-acrylonitrile copolymer present on a weight basis. The reinforcing agent preferably includes fiberglass and may consist of fiberglass in some cases while in others there is further provided a mineral filler.

Preferably, when molded the compositions exhibit a relative warp of less than about 150 percent and still more preferably exhibit a relative warp of less than about 125 percent. The composition generally has a melt viscosity at 250° C. and 1000 1/sec of less than bout 3000 poise and preferably has a melt viscosity at 250° C. and 1000 1/sec of less than about 2500 poise. So also, the composition generally has a temperature of deflection under load of at least about 170° C. at 1.8 Mpa; typically even higher. Optionally, there is further provided to the composition an impact modifier selected from the group consisting of ionomeric impact modifiers, multiphase polymers and ethylene/acrylic copolymer impact modifiers. The impact modifier may be present in an amount of from about 2 weight percent to about 15 weight percent; preferably the impact modifier is present in an amount of from about 4 weight percent to about 10 weight percent.

In another aspect of the invention, there is provided a low warp, reinforced composition consisting essentially of a melt blend of polybutylene terephthalate, styrene-acrylonitrile copolymer and a reinforcing agent, optionally including one or more impact modifiers, stabilizers and lubricants wherein: (i) the polybutylene terephthalate resin has an intrinsic viscosity of from about 0.4 to about 4; (ii) the styrene-acrylonitrile copolymer has a melt index of from about 2 g/10 minutes to about 10 g/10 minutes at 230° C./3.8 kg; and (iii) the polybutylene terephthalate resin is present in an amount of from about 1.5 to about 3 times the amount of styrene-acrylonitrile copolymer present on a weight basis.

Still yet another aspect of the invention is directed to a method of making an injection molded part comprising: (a) melt blending a composition comprising: (i) from about 30 weight percent to about 70 weight percent of polybutylene terephthalate resin; (ii) from about 10 weight percent to about 30 weight percent of a styrene-acrylonitrile copolymer; (iii) from about 15 weight percent to about 60 weight percent of a reinforcing agent, (iv) optionally including one or more impact modifiers, lubricants and stabilizers; and (b) injection molding the melt blend of step (a) into a shaped article. Preferably, the process further includes the step of pelletizing the melt blend. Generally, the components are melt blended at a temperature of from about 215° C. to about 245° C.

Further aspects and advantages of the present invention will become apparent form the following detailed description.

### DETAILED DESCRIPTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined, terminology is given its ordinary meaning. Percent, for example, refers to weight percent.

“Styrene-acrylonitrile copolymer” or “SAN” is a copolymer which is typically prepared by copolymerization of from about 68% to about 80% (preferably from about 70% to about 78%) styrene and from about 20% to about 32% (preferably from about 22% to about 30%) of acrylonitrile. The molecular weight of SAN can be varied within a wide range, generally from about 30,000 to about 600,000. SAN is readily produced by known processes such as mass, solution, suspension, or emulsion polymerization. “SAN copolymer” as used in this specification and appended claims means SAN copolymer at least 80 mol percent of which consists of styrene and acrylonitrile derived repeating units. While the use of minor amounts of other co monomers is not excluded, the present invention is not intended to encompass the use of acrylonitrile-butadiene-styrene copolymer (ABS) or other impact modifier as the SAN copolymer component recited in the claims. Such impact modifiers are not excluded as optional additional components and may be present if so desired. Two preferred SAN resins and Tyril® 880B and 990 available from Dow Plastics. Representative properties of these resins appear in Table I below.

TABLE 1
Selected Styrene/Acrylonitrile Resin Properties

| Property | Test Method | Tyril ® 880B | Tyril ® 990 |
|---|---|---|---|
| Melt Index, | ASTM D 1238 | 3.2 g/10 min | 8.5 g/10 min |
| 230° C./3.8 kg | | | |
| DTUL at 1.8 Mpa | ASTM D 648 | 86° C. | 97° C. |
| Vicat Softening Point | ASTM D 1525 | 108° C. | 107° C. |

“Polybutylene terephthalate”, “PBT” is a polyester obtained by polymerizing a glycol component, at least 70 mole preferably at least 80 mole %, of which consists of tetramethylene glycol (1,4-butanediol or 1,4-butylene glycol) and an acid component at least 70 mole %, preferably at least 80 mole %, of which consists of terephthalic acid, or polyester-forming derivatives thereof. Also contemplated are mixtures of the ester with minor amounts, e.g., from 0.5 to 2% by weight, of units derived from aliphatic or aromatic dicarboxylic acids and/or aliphatic polyols, e.g., glycols, i.e., copolyesters. These can be made by following the teachings outlined in Whinfield et al., U.S. Pat. No. 2,465,316 and Pengilly, U.S. Pat. No. 3,047,539, for example. Among the units which can be present in the copolyesters are those derived from aliphatic dicarboxylic acids, e.g., of up to about 50 carbon atoms, including straight and branched chain acids, such as adipic acid, dimerized C₁₆-C₁₈ unsaturated acids (which have 32 to 36 carbon atoms), trimerized such acids, and the like. Among the units in the copolyesters can also be minor amounts derived from aromatic dicarboxylic acids, e.g., of up to about 36 carbon atoms, such as isophthalic acids and the like. In addition to the 1,4-butylene glycol units, there can also be minor amounts of units derived from other aliphatic glycols and polyols, e.g., of up to about 50 carbon atoms, including ethylene glycol, propylene glycol, glycerol and the like. Such copolyesters can be made by techniques well known to those skilled in the art. Poly(1,4-butylene terephthalate) copolymer is the preferred polyester and is commercially available.

These polymeric 1,4-butylene glycol terephthalates have an intrinsic viscosity of at least 0.4 and preferably at least about 0.7 deciliters/gram as measured in o-chlorophenol, a 60/40 phenol tetrachloroethane mixture or a similar solvent at 25°-30° C. The upper limit is not critical, but it will generally be about 4.0 dl./g. Especially preferred PBT resins will have an intrinsic viscosity in the range of about 0.7 to 2.0.

The reinforcing agents used are typically reinforcing fibers. Suitable reinforcing agents include, for example, glass fiber, carbon fiber, ceramic fiber, fibrous potassium titanate, iron whiskers, and the like. Glass is the most preferred. While fiber is the most preferred form for the reinforcing agent, other suitable forms may also be employed in the practice of the invention. Where reinforcing fibers are used, such fibers should normally have diameters between about 5 and about 30 microns, typically from 10-21 microns and preferably from 11-16 microns. Aspect ratios (ratio of length of fiber to diameter of fiber) are desirably at least about 5. The reinforcing fiber typically has a length prior to compounding of generally from less than 1-10 mm, preferably from 2-6 mm and more preferably from 3-5 mm. After compounding and/or molding, the fibers are considerably shorter, generally in the range of 0.2-0.5 mm in length with the average length typically toward the lower value of 0.2 mm. Glass fibers, where used, preferably have diameters between about 10 and about 15 microns and an initial aspect ratio of at least about 20. Fillers may also be included. Suitable fillers include, but are not limited to, mica, talcum, clay, titanium dioxide, calcium carbonate and the like. There may be variants within the same filler type such as, for example, the muscovite type mica (supplied by KMG, Inc.), the phlogopite type mica (Suzorite, Inc.) and the like. Nanofillers, that is, exfoliated minerals, are considered both reinforcing agents and mineral fillers for purposes of the present invention. Suitable nanofillers are exfoliated layered minerals including exfoliated clays such as montmorillonite, other exfoliated silicates and so forth as are known in the art.

“Impact modifier” and such terminology means and includes polymers used to toughen engineering resin compositions, including core-shell elastomers, ethylene/methacrylate copolymers, ionomers and so forth as are known in the art. Lotader® impact modifiers, available from Atofina are used in some compositions. These resins are copolymers of ethylene and acrylic esters with a reactive functionality. This reactive group can either be maleic anhydride (MAH), very polar and giving chemical reaction on —NH2, —OH, epoxy group, or glycidyl methacrylate (GMA) of which epoxy group can react on COOH, —OH, —NH2. The acrylic ester can be methyl, ethyl or butyl acrylate.

Also as part of the polyester resin of the polyester composition are conventional additives known to the art. Some of them include, for example, antioxidants, stabilizers, lubricants, nucleating agents, colorants, mold release agents, ultraviolet light stabilizers, and the like. Examples of suitable antioxidants include phosphites. Examples of suitable stabilizers include bis-phenol A based epoxy. Examples of suitable lubricants include olefinic waxes, EBS waxes and the like.

In preparing molded compositions of the invention, the components may be intimately blended by any suitable means. Melt-compounding by extrusion at about 230° C. is preferred. The extrusion may be carried out in a suitable extruder such as for example a twin screw extruder with down-stream feeding capability. Many such extruders are commercially available such as, for example, the 40 mm Werner Pleiderer twin screw extruder. The extruder is fed with the resin composition and temperatures are kept at a suitable level, for example, the temperature may range 210° C. to 250° C. Likewise, in molding parts, barrel temperatures between about 230° C. and 275° C. are preferred. In a preferred embodiment, the molding composition of the invention is formed by extrusion and pelletized. Products of the invention are then produced by injection molding the pelletized extrudate into a mold having a surface temperature of 40° C. or so.

The fiberglass reinforced polybutylene and styrene-acrylonitrile composition of the invention and optionally containing the impact modifier, when obtained by the end user, may be dried by any convenient method, re-melted and molded.

Unless otherwise indicated, the following test procedures are used to characterize the compositions and products of the invention.

| | |
|---|---|
| Relative Warp | ISO 9001/ASTM D 792 |
| Melt Index or Viscosity | ISO 1133/ASTM D 1238 |
| DTUL | ISO 75/ASTM D 648 |
| Tensile Properties | ISO 527/ASTM D 638 |
| Izod Impact Notched | ISO 180/ASTM D 256 |
| Shrinkage | ISO 294/ASTM D 955 |
| Injection Molded | ISO 7792-2 |
| Specimen Preparation | |

Unless otherwise indicated, the test method version in effect on Jul. 1, 2004 is used.

The following examples illustrate preferred compositions and methods of the present invention. These examples are illustrative only and do not limit the scope of the invention. All percentages are by weight unless otherwise indicated.

### COMPARATIVE EXAMPLES A, B AND INVENTION EXAMPLES 1-4

A variety of PBT/SAN blends reinforced with fiberglass and optional impact modifier were studied. The indicated components were incorporated into compositions at the amounts indicated in Table 2 by melt-compounding, followed by injection molding test specimens in accordance with ISO test method 7792-2.

In connection with Table 2 and 3 the following ingredients were used:

| | |
|---|---|
| Fiberglass | PPG 3540 (PPG) |
| PBT | Virgin PBT injection molding grade resin (Ticona) |
| SAN | Tyril ® 880B and 990 (Dow) |
| Polycarbonate | Recycled Polycarbonate |
| Impact Modifier | Lotader ® 8930 (Atofina) |
| Additives | Lubricants, antioxidants |

“Commercial Product: indicates a commercial reinforced PBT-based, 30 percent glass fiber reinforced product marketed by Ticona, based on the same Virgin PBT resin used in the other examples.

Property data appears for the various compositions in Table 3.

TABLE 2
Test Compositions

| | Example | | | | | |
|---|---|---|---|---|---|---|
| Component | A | 1 | 2 | 3 | 4 | B |
| Commercial Product | 100% | — | — | — | — | — |
| PBT | — | 50% | 45% | 50% | 45% | 45% |
| Fiberglass (PPG 3540) | — | 30% | 30% | 30% | 30% | 30% |
| Polycarbonate | — | — | — | — | — | 20% |
| Tyril 880B SAN | — | 20% | 20% | — | — | — |
| Tyril 990 SAN | — | — | — | 20% | 20% | — |
| Impact Modifier | — | — | 5% | — | 5% | 5% |
| Additives | — | — | — | — | — | — |

TABLE 3
Properties of Compositions and Molded Products.

| | Example | | | | | |
|---|---|---|---|---|---|---|
| | A | 1 | 2 | 3 | 4 | B |
| Tensile Strength at Break (MPa) | 115.7 | 118.9 | 111.5 | 119.8 | 112.3 | 111.4 |
| Tensile Elongation (%) | 2.3 | 2.0 | 2.2 | 2.0 | 2.1 | 3.2 |
| Tensile Modulus (Mpa) | 9255 | 9832 | 9664 | 9719 | 9227 | 8547 |
| Notched Izod (kJ/m²) | 7.8 | 6.9 | 7.1 | 7.1 | 7.7 | 14.0 |
| DTUL @ 1.80 Mpa (C. °) | 200 | 176 | 172 | 177 | 170 | 154 |
| Melt Viscosity (poise) | 2444 | 2470 | 2749 | 2088 | 2183 | 6207 |
| Rate of Change (% min) | −0.68 | −0.28 | 0.22 | −0.17 | 0.46 | −1.09 |
| Relative Warp (%) | 257 | 117 | 119 | 125 | 128 | 100 |
| Shrinkage @ 4 mm (mils/in) | 1.1 | 0.9 | 1.3 | 1.3 | 0.9 | 1.0 |

As will be appreciated from the foregoing, compositions of the invention exhibit reduced warp, as well as melt viscosities and DTUL temperatures comparable to compositions with PBT only as the matrix resin. On the other hand, the PBT/polycarbonate composition exhibited high melt viscosity and reduced deflection temperatures under load.

Articles prepared by way of the invention include many automotive applications including connectors, sensors, housings, and other products benefiting from the combination of warp resistance, easy mold filling and high DTUL. Competitive products do not have this unique combination of properties.

While the invention has been described in connection with several examples, modifications to those examples within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary.

What is claimed is:

1. A low warp, reinforced polybutylene terephthalate molding composition comprising:
(a) from about 30 weight percent to about 70 weight percent of polybutylene terephthalate resin;
(b) from about 10 weight percent to about 30 weight percent of a styrene-acrylonitrile copolymer;
(c) from about 15 to about 60 weight percent of a reinforcing agent; and
(d) optionally including one or more impact modifiers, lubricants and stabilizers.

2. The composition according to claim 1, wherein the polybutylene terephthalate resin is present in an amount of from about 40 weight percent to about 60 weight percent.

3. The composition according to claim 1, wherein the polybutylene terephthalate resin has an intrinsic viscosity of from about 0.4 to about 4.0.

4. The composition according to claim 1, wherein the polybutylene terephthalate resin has an intrinsic viscosity of from about 0.6 to about 1.5.

5. The composition according to claim 1, wherein the styrene-acrylonitrile copolymer is present in an amount of from about 15 to about 25 weight percent.

6. The composition according to claim 1, wherein the styrene-acrylonitrile copolymer has a melt index of from about 2 g/10 min to about 10 g/10 min at 230° C./3.8 kg.

7. The composition according to claim 1, wherein the styrene-acrylonitrile copolymer has a melt index of from about 2 g/10 min to about 9 g/10 min at 230° C./3.8 kg.

8. The composition according to claim 1, wherein the styrene-acrylonitrile copolymer has a melt index of from about 3 g/10 min to about 3.5 g/10 min at 230° C./3.8 kg.

9. The composition according to claim 1, wherein the amount of polybutylene terephthalate resin present is at least 1.5 times the amount of styrene-acrylonitrile copolymer present on a weight basis.

10. The composition according to claim 1, wherein the amount of polybutylene terephthalate resin present is at least 2 times the amount of styrene-acrylonitrile copolymer present on a weight basis.

11. The composition according to claim 1, wherein the reinforcing agent comprises fiberglass.

12. The composition according to claim 1, wherein the reinforcing agent consists of fiberglass.

13. The composition according to claim 1, further comprising a mineral filler.

14. The composition according to claim 1, having a relative warp of less than about 150 percent.

15. The composition according to claim 1, having a relative warp of less than about 125 percent.

16. The composition according to claim 1, having a melt viscosity at 250° C. and 1000 1/sec of less than about 3000 poise.

17. The composition according to claim 1, having a melt viscosity at 250° C. and 1000 1/sec of less than about 2500 poise.

18. The composition according to claim 1, wherein the composition has a temperature of deflection under load of at least about 170° C. at 1.8 Mpa.

19. The composition according to claim 1, including an impact modifier selected from the group consisting of ionomeric impact modifiers, multiphase polymers and ethylene/acrylic copolymer impact modifiers.

20. The composition according to claim 19, wherein the impact modifier is present in an amount of from about 2 weight percent to about 15 weight percent.

21. The composition according to claim 19, wherein the impact modifier is present in an amount of from about 4 weight percent to about 10 weight percent.

22. A low warp, reinforced composition consisting essentially of a melt blend of polybutylene terephthalate, styrene-acrylonitrile copolymer and a reinforcing agent, optionally including one or more impact modifiers, stabilizers and lubricants wherein:
(i) the polybutylene terephthalate resin has an intrinsic viscosity of from about 0.4 to about 4;
(ii) the styrene-acrylonitrile copolymer has a melt index of from about 2 g/10 minutes to about 10 g/10 minutes at 230° C./3.8 kg; and
(iii) the polybutylene terephthalate resin is present in an amount of from about 1.5 to about 3 times the amount of styrene-acrylonitrile copolymer present on a weight basis.

23. A method of making an injection molded part comprising:
(a) melt blending a composition comprising:
(i) from about 30 weight percent to about 70 weight percent of polybutylene terephthalate copolymer;
(ii) from about 10 weight percent to about 30 weight percent of a styrene-acrylonitrile resin;
(iii) from about 15 weight product to about 60 weight percent of a reinforcing agent;
(iv) optionally including one or more impact modifiers, lubricants and stabilizers; and
(b) injection molding the melt blend of step (a) into a shaped article.

24. The method according to claim 23, further comprising the step pf pelletizing the melt blend.

25. The method according to claim 23, wherein the components are melt blended at a temperature of from about 215° C. to about 245° C.
